(19) United States
(12) Patent Application Publication
(10) Pub. No.: US 2021/0374431 A1
(43) Pub. Date: Dec. 2, 2021

(54) VIDEO SURVEILLANCE APPARATUS FOR CONGESTION CONTROL

(71) Applicant: ITX-AI Co., Ltd., Seoul (KR)

(72) Inventors: Jong Bin Yim, Pohang-si (KR); Dong Uk Park, Gwangmyeong-si (KR); Byung Yun Lee, Seongnam-si (KR)

(73) Assignee: ITX-AI Co., Ltd., Seoul (KR)

(21) Appl. No.: 17/326,369

(22) Filed: May 21, 2021

(30) Foreign Application Priority Data
May 29, 2020 (KR) 10-2020-0065272

(51) Int. Cl. G06K 9/00; G06T 7/70; G06T 7/50; H04N 7/18

(52) U.S. Cl. CPC G06K 9/00778; G06T 7/70; G06K 9/00362; G06T 2207/30232; H04N 7/18; G06T 2207/30196; G06T 2207/10016; G06T 7/50

(57) ABSTRACT

Disclosed is a video surveillance technique for performing automated surveillance through intelligent video recognition. A distance between two persons is measured from an image captured by a camera. When the measured distance is less than or equal to a reference value, a proximity event occurs. In an embodiment, feet of two persons are detected from an image captured by a camera and a distance between the two persons is calculated using a distance between positions on the ground at which the feet are placed by using camera parameters. In another embodiment, heads of two persons are detected from an image captured by a camera and a distance between the two persons is calculated using a distance between positions of the heads on a plane corresponding to an average height.

### CROSS-REFERENCE TO RELATED APPLICATION(S)

This application claims priority from Korean Patent Application No. 10-2020-0065272, filed on May 29, 2020, in the Korean Intellectual Property Office, the disclosure of which is incorporated herein by reference in its entirety.

### BACKGROUND

### 1. Field

Embodiments of the present invention relate to a video processing technique, and more particularly, to a video surveillance technique for performing automated surveillance through intelligent video recognition.

### 2. Description of Related Art

As infectious diseases have been spreading, the concept of social distancing has emerged and maintaining distance between individuals is becoming an important issue. When buildings are closed due to the infectious diseases, the tenants' business and livelihoods are greatly affected. Therefore, managers who manage spaces for many people to enter and exit have become very interested in maintaining such social distancing with respect to the people entering and exiting the spaces managed by the managers.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an automated technique for managing social distancing maintenance between people entering and exiting a space.

In one general aspect, a distance between two persons is measured from an image captured by a camera. When the measured distance is less than or equal to a reference value, a proximity event occurs.

In another general aspect, feet of two persons may be detected from an image captured by a camera and a distance between the two persons may be calculated using a distance between positions on the ground at which the feet are placed by using camera parameters.

In still another general aspect, heads of two persons may be detected from an image captured by a camera and a distance between the two persons may be calculated using a distance between positions of the heads on a plane corresponding to an average height by using camera parameters.

In yet another general aspect, heads of persons may be detected in a circle having a predetermined size based on a center of a screen in an image input from a wide angle camera that is installed to face downward, and the number of pixels between the detected heads of the persons may be converted into a distance to calculate a distance between two persons.

In yet another general aspect, a proximity event may occur according to a reference value which is determined in consideration of not only a distance between two persons but also a proximity maintenance time between the two persons.

In yet another general aspect, a proximity event may occur according to a reference value which is determined in consideration of not only a distance between two persons but also whether the two persons wear masks.

In yet another general aspect, a proximity event may occur according to a reference value which is determined in consideration of not only a distance between two persons but also whether the two persons face each other.

Other features and aspects will be apparent from the following detailed description, the accompanying drawings, and the claims.

### BRIEF DESCRIPTION OF THE DRAWINGS

FIG. 1 is a block diagram illustrating a configuration of a video surveillance apparatus for congestion control according to an embodiment.

FIG. 2 is a diagram for describing a relationship between an image coordinate system and a ground coordinate system.

FIG. 3 is a block diagram illustrating a configuration of a video surveillance apparatus for congestion control according to another embodiment.

FIG. 4 is a flowchart illustrating a procedure of a video surveillance method for congestion control according to an embodiment.

FIG. 5 is a flowchart illustrating detailed procedures of a foot-to-foot distance calculation operation and a head-to-head distance calculation operation according to an embodiment.

FIG. 6 is a flowchart illustrating a procedure of a video surveillance method for congestion control according to another embodiment.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The above-described aspects and additional aspects are embodied through embodiments described with reference to the accompanying drawings. It will be understood that components of each of the embodiments may be combined in various ways within one embodiment unless otherwise stated or there is a contradiction between them. Terms and words used in this specification and claims should be interpreted with meanings and concepts which are consistent with the description or proposed technological scope of the present invention based on the principle that the inventors have appropriately defined concepts of terms in order to describe the present invention in the best way. Hereinafter, exemplary embodiments of the present invention will be described in detail with reference to the accompanying drawings.

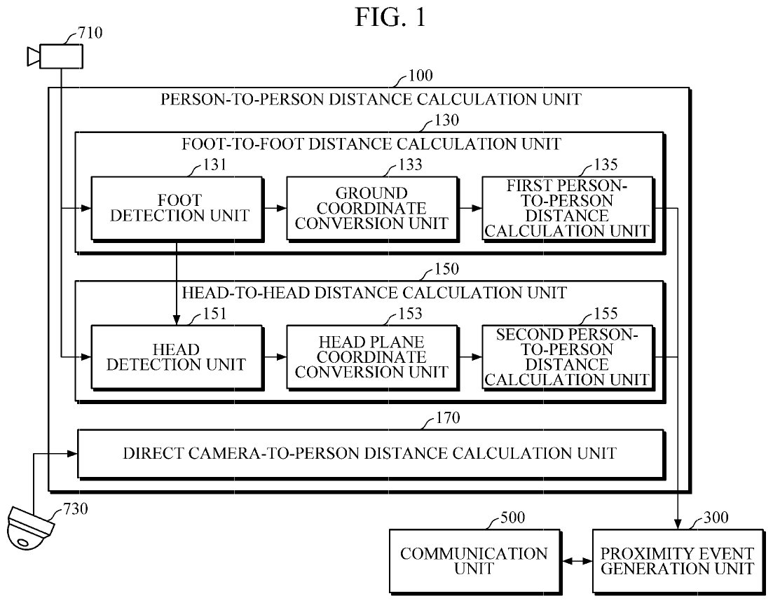

FIG. 1 is a block diagram illustrating a configuration of a video surveillance apparatus for congestion control according to an embodiment. In the illustrated example, the video surveillance apparatus is installed in spaces, for example, stores, offices, public buildings, or even outdoor controlled spaces. The video surveillance apparatus may be formed in the form of a set-top box, a computer, a monitor-integrated surveillance apparatus, or the like. The video surveillance apparatus may be implemented as computer program instructions to be executed in a microprocessor. In the drawing, each of blocks included in the video surveillance apparatus may be implemented as a computer program instruction set that performs a corresponding function.

According to an aspect of the present invention, a distance between two persons is measured from an image captured by a camera. The video surveillance apparatus for congestion control according to the embodiment includes a person-to-person distance calculation unit 100 and a proximity event generation unit 300. The person-to-person distance calculation unit 100 calculates a value of a person-to-person distance, which is a value of a distance between two persons in an image captured by a camera 710. For example, two persons may be identified from the captured image, and central coordinates of body parts, such as faces or torso, of the two persons may be detected. When camera parameters are given, absolute coordinate information corresponding to an absolute distance may be obtained. Additionally, when the ground includes a curved surface rather than a flat surface, the person-to-person distance may be more accurately calculated using a mark image having a known length which is present on a screen.

The proximity event generation unit 300 transmits a proximity event when the calculated value of the person-to-person distance is less than or equal to a reference value. For example, the reference value may be six feet, which is a social distancing criterion. For example, a proximity event signal generated by the proximity event generation unit 300 may be transmitted to a control system connected to a network through a communication unit 500. As another example, the proximity event may be transmitted to a broadcasting system to transmit a warning broadcast. When the video surveillance apparatus is linked with a facial recognition system, a warning message may be transmitted to a mobile terminal of a person who frequently generates the proximity event through a mobile network.

According to another aspect, feet of two persons may be detected from the image captured by the camera 710, and a distance between the two persons may be calculated using a distance between positions on the ground, at which the feet are placed, using the camera parameters. The person-to-person distance calculation unit 100 according to the illustrated embodiment may include a foot-to-foot distance calculation unit 130. The foot-to-foot distance calculation unit 130 detects feet of two persons from the image captured by the camera 710 and calculates a value of a person-to-person distance using coordinates of an image coordinate system of the image. The image coordinate system refers to coordinates based on coordinate axes set on a plane when it is assumed that the image captured by the camera 710 is a plan view. Coordinates of the foot are set to one of easily detectable positions, for example, a front end of the foot or a central point of the foot.

According to an additional aspect, the foot-to-foot distance calculation unit 130 may include a foot detection unit 131, a ground coordinate conversion unit 133, and a first person-to-person distance calculation unit 135. The foot detection unit 131 detects the feet of the two persons from the image captured by the camera 710 and obtains a pair of first position coordinates, which are coordinates of the image coordinate system. The method of obtaining the distance between two persons from the positions of the two persons placed on the ground is more accurate and efficient than other methods. The detection of the foot attached to the ground is usually advantageous in order to determine the position on the ground, and the detection of the foot from the image captured by the camera 710 is advantageous because the image is processed fairly reliably with a technique known in the conventional surveillance video analytic. The central point of the detected foot region may be obtained and the coordinates of the central point may be obtained from the image coordinate system.

The ground coordinate conversion unit 133 converts the pair of first position coordinates into a pair of second position coordinates of a ground coordinate system using the camera parameters.

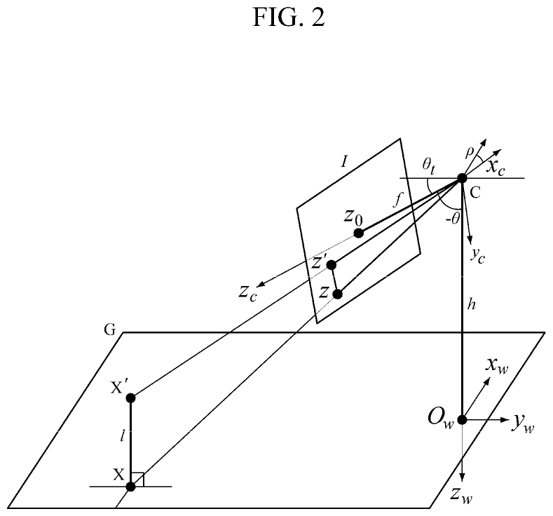

FIG. 2 is a diagram for describing a relationship between an image coordinate system and a ground coordinate system. In the drawing, I denotes an image plane, G denotes a ground plane, and C denotes a center of a camera. Ow denotes an origin of the world coordinate system.

Through an image calibration process of the camera, an intrinsic parameter and an extrinsic parameter may be obtained. The intrinsic parameter refers to internal information of the camera, such as structural errors of the camera caused by lens distortion or the like. The extrinsic parameter refers to information on how much the actually installed camera is moved from the origin of the world coordinate system and how much the camera is rotated.

The camera parameters may be expressed through a matrix and a vector. The origin of the real world may be arbitrarily set. Three-dimensional (3D) coordinates of the real world may be expressed as coordinates of a two-dimensional (2D) image plane using a homogeneous coordinate system. When it is assumed that a Z-axis value of the 3D coordinates of the real world is zero, it becomes a 2D plane having XY coordinates, and the 2D plane may be a 2D image captured by the camera. A homography technique is known in which a feature point is found in a 2D image and changed as if viewed from a different angle. In Korean Patent No. 1,489,468 invented by an inventor who is one of the inventors of the present application, a camera image calibration technique based on a homography is proposed and the background art thereof well described in the specification.

Unless the space is congested with many people, all feet of persons detected are detectable. According to an aspect of the present invention, coordinates of an image are converted into coordinates on the ground plane by applying a homography between the image plane and the ground plane, and then a person-to-person distance is calculated using the coordinates on the ground plane.

In FIG. 2, when a person located on the ground plane is expressed as a line segment X-X′ having a length l, the person is expressed as a line segment Z-Z′ having a reduced length on the image plane. An x_{c}-y_{c}-z_{c} coordinate system is an image coordinate system and an x_{w}-y_{w}-z_{w} coordinate system is a ground coordinate system. A homography is applied between an x_{c}-y_{c} plane, which is an image plane, and an x_{w}-y_{w} plane, which is a ground plane. Camera parameters include a tilt θ, a roll ρ, and a camera height h, and an intrinsic parameter is expressed as a focal length f. As illustrated in the drawing, a homography matrix Hₗ on two planes may be obtained from

$${H}_{I} = [ \begin{matrix}\frac{1}{f} cos ρ & \frac{1}{f} sin ρ & - \frac{{u}_{0}}{f} cos ρ - \frac{{v}_{0}}{f} sin ρ \\ - \frac{1}{f} cos θ sin ρ & \frac{1}{f} cos θ cos ρ & \begin{matrix}\frac{{u}_{0}}{f} cos θ sin ρ - \\ \frac{{v}_{0}}{f} cos θ cos ρ + sin θ\end{matrix} \\ \frac{1}{fh} sin θ sin ρ & - \frac{1}{fh} sin θ cos ρ & \begin{matrix}- \frac{{u}_{0}}{fh} sin θ sin ρ + \\ \frac{{v}_{0}}{fh} sin θ cos ρ + \frac{1}{h } cos θ\end{matrix}\end{matrix} ]$$

the camera parameters as follows.

The ground coordinates x=(x, y) of the image coordinates z=(u, v) are calculated as follows.

$$x = \frac{1}{s} [ \begin{matrix}{h}_{n} \\ {h}_{12}\end{matrix} ] \tilde{z}$$

Here, \tilde{z}=(u, v, 1), s=hₗ₃\tilde{z}, and hₗⱼ denotes a j^{th} column of H₁.

The first person-to-person distance calculation unit 135 calculates a distance between the pair of second position coordinates and outputs the calculated distance as the value of the person-to-person distance. When the ground coordinates x₁=(x₁, y₁) and x₂=(x₂, y₂) of two coordinates (e.g., coordinates of feet of the person detected) z₁ and z₂ on the image are obtained as above, a distance d between two persons may be obtained from the above ground coordinates as follows.

d=∥x₁-x₂∥=\sqrt{(x₁-x₂)²+(y₁-y₂)²}

According to another aspect, heads of two persons may be detected from the image captured by the camera, and a distance between the two persons may be calculated using a distance between positions of the heads on a plane corresponding to an average height using the camera parameters. In the video surveillance apparatus according to the aspect, the person-to-person distance calculation unit 100 may include a head-to-head distance calculation unit 150. The head-to-head distance calculation unit 150 detects heads of two persons from the image captured by the camera and calculates a value of a person-to-person distance using coordinates on an image coordinate system of the image. Coordinates of the head are set to one of easily detectable positions, for example, an upper end of the head or a central point of the head.

According to an additional aspect, the head-to-head distance calculation unit 130 may include a head detection unit 151, a head plane coordinate conversion unit 153, and a second person-to-person distance calculation unit 155. The head detection unit 151 detects the feet of the two persons from the image captured by the camera and obtains the pair of third position coordinates, which are coordinates of the image coordinate system. With recent advances in facial recognition technique, the detection of the head is processed with significant reliably. A central point of the detected head region may be obtained and coordinates thereof may be obtained from the image coordinate system.

The head plane coordinate conversion unit 153 converts the pair of third position coordinates into a pair of fourth position coordinates of a head plane coordinate system corresponding to an average height of persons using the camera parameters. As described above, the technique in which the coordinates of the image plane are converted into the coordinates of the head plane may be processed using the homography technique.

According to an additional aspect, in the embodiment illustrated in FIG. 1, the foot detection unit 131 detects regions at which two persons of whom the distance is intended to be measured are positioned and then calls the head-to-head distance calculation unit 150 when the foot detection unit 131 fails to detect the feet of the two persons. Accordingly, when the foot detection unit 131 fails to calculate the distance between the feet, the calculation of the distance between the heads may be applied.

According to an additional aspect, the person-to-person distance calculation unit 100 may further include a direct camera-to-person distance calculation unit 170. The direct camera-to-person distance calculation unit 170 detects heads of persons in a circle having a predetermined size based on a center of a screen in the image input from a wide angle camera 730 that is installed to face downward and converts the number of pixels between the detected heads of the persons into a distance to calculate the person-to-person distance. An image with almost no distortion is obtained in the circle having the predetermined size based on the center of the screen. A radius of the circle may vary according to a distortion rate of a lens of the camera and software of the camera. The number of pixels between the central points of the head regions is proportional to the actual distance. Therefore, the distance may be calculated by multiplying the distance by the ratio value that varies according to the installation height of the camera.

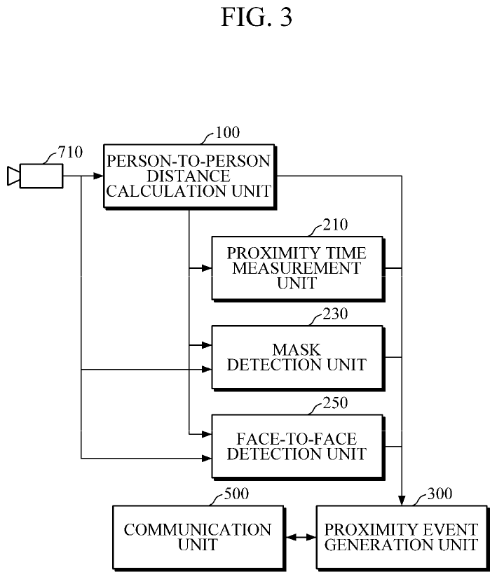

FIG. 3 is a block diagram illustrating a configuration of a video surveillance apparatus for congestion control according to another embodiment. According to an aspect, the video surveillance apparatus may further include a proximity time measurement unit 210. The proximity time measurement unit 210 measures and outputs a proximity maintenance time for which a corresponding distance between two persons is maintained when a proximity event occurs. The proximity maintenance time may be a time value measured while the value of the distance between the two persons output from the person-to-person distance calculation unit 100 is not changed to a predetermined value or more. When the value of the distance between the two persons is changed during a conversation, the proximity time measurement unit 210 measures the time maintained within the corresponding distance for each distance. For example, when the two persons maintain a distance of 2 m and approach each other at a distance of 1.5 m, the time measured at the distance of 2 m continues to be measured at the distance of 1.5 m, and the measurement of the distance of 1.5 m starts anew.

In this case, the proximity event generation unit 300 receives the value of the person-to-person distance output from the person-to-person distance calculation unit 100 and the proximity maintenance time output from the proximity time measurement unit 210 as inputs and transmits the proximity event according to a distance reference value for each proximity maintenance time. The distance reference value for each proximity maintenance time may be set to, for example, one minute for 2 m, three minutes for 2.5 m, five minutes for 3 m, or the like in advance. For example, according to the above criteria, when the two persons maintain the distance of 2 m for 30 seconds and then further continue maintaining the distance of 1.5 m for 30 seconds, the two persons maintain the distance of 2 m for one minute so that the proximity event is transmitted. Proximity event information may include the distance and a history of the maintenance time.

According to another aspect, the video surveillance apparatus may further include a mask detection unit 230. The mask detection unit 230 determines whether the two persons wear masks when the proximity event occurs. In an embodiment, when the proximity event occurs, the mask detection unit 230 may identify the two persons on the image from the coordinate values of the two persons output from the person-to-person distance calculation unit 100, extract face regions of the two persons, and then analyze the faces on the image to determine whether the two persons wear the masks.

In this case, the proximity event generation unit 300 receives the value of the person-to-person distance output from the person-to-person distance calculation unit 100 and the information on whether the two persons wear the masks output from the mask detection unit 230 as inputs and transmits the proximity event according to a distance reference value according to whether the two persons wear the masks. The distance reference value according to whether the two persons wear the masks may be set to, for example, 1 m when both of the two persons wear masks, 2 m when only one of the two persons wears a mask, 2.5 m when neither of the two persons wears a mask, or the like in advance.

According to another aspect, the video surveillance apparatus may further include a face-to-face detection unit 250. The face-to-face detection unit 250 determines whether the two persons face each other when the proximity event occurs. In an embodiment, when the proximity event occurs, the face-to-face detection unit 250 may identify the two persons on the image from the coordinate values of the two persons output from the person-to-person distance calculation unit 100, extract face regions of the two persons, analyze the faces on the image to extract facial direction vectors facing the faces of the two persons, and determine that the two persons face each other when a difference vector between the two vectors is within a predetermined range.

In this case, the proximity event generation unit 300 receives the value of the person-to-person distance output from the person-to-person distance calculation unit 100 and the information on whether the two persons face each other output from the face-to-face detection unit 250 as inputs and transmits the proximity event according to a distance reference value according to whether the two persons face each other. The distance reference value according to whether the two persons face each other may be set in advance to, for example, 2 m when the two persons face each other, 2.5 m when the two persons do not face each other, or the like.

In the embodiment illustrated in FIG. 3, the proximity event generation unit 300 receives the value of the person-to-person distance output from the person-to-person distance calculation unit 100, the proximity maintenance time output from the proximity time measurement unit 210, the information on whether the two persons wear the masks output from the mask detection unit 230, and the information on whether the two persons face each other output from the face-to-face detection unit 250 as inputs and transmits the proximity event according to a reference value set according to a combination thereof. Here, the reference value may be set in advance for each combination of the range of the proximity time, whether the two persons wear the masks, and whether the two persons face each other.

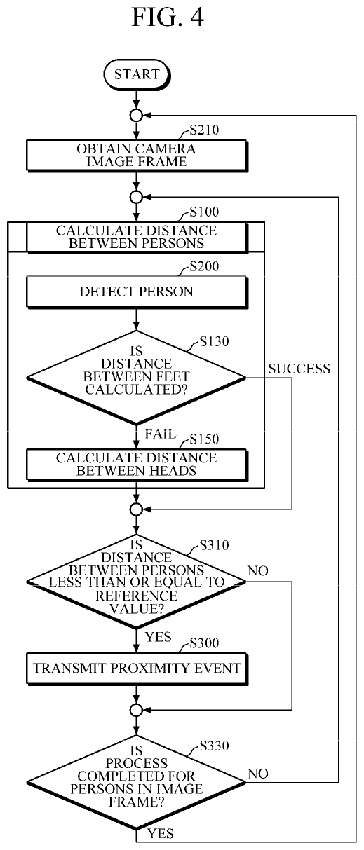

FIG. 4 is a flowchart illustrating a procedure of a video surveillance method for congestion control according to an embodiment. The video surveillance method for congestion control according to the embodiment includes a person-to-person distance calculation operation S100 and a proximity event generation operation S300. First, an image frame captured by a camera is obtained (operation S210). Every frame of the image captured by the camera does not necessarily need to be analyzed, and may be sampled at an appropriate rate, such as one frame every five seconds, in consideration of a moving speed of a person. In the person-to-person distance calculation operation S100, the surveillance apparatus calculates a value of a person-to-person distance, which is a value of a distance between two persons, in the image captured by the camera 710. In the proximity event generation operation S300, the surveillance apparatus transmits a proximity event when the calculated value of the person-to-person distance is less than or equal to a reference value. These operations are similar to those of the person-to-person distance calculation unit 100 and the proximity event generation unit 300 described in FIG. 1.

In the person-to-person distance calculation operation S100, the surveillance apparatus may include a foot-to-foot distance calculation operation S130. In the foot-to-foot distance calculation operation S130, the surveillance apparatus detects feet of two persons from the image captured by the camera 710 and calculates a value of a person-to-person distance using coordinates of an image coordinate system of the image.

According to another aspect, the person-to-person distance calculation operation S100 may include a head-to-head distance calculation operation S150. In the head-to-head distance calculation operation S150, the surveillance apparatus detects heads of two persons from the image captured by the camera and calculates a value of a person-to-person distance using coordinates of the image coordinate system of the image. According to an aspect, in the foot-to-foot distance calculation operation S130, when the surveillance apparatus fails to calculate the foot-to-foot distance, the head-to-head distance calculation operation S150 may be performed. However, it is also possible to determine by combining the methods, such as performing both of the above methods at the same time and selecting one of the methods or averaging the methods.

Thereafter, the value of the person-to-person distance calculated in the person-to-person distance calculation operation S100 is compared to the reference value (operation S310). When the value of the person-to-person distance is less than or equal to the reference value, the proximity event is transmitted (operation S300). When the value of the person-to-person distance is greater than the reference value, it is determined whether the person-to-person distance calculation operation S100 and the proximity event generation operation S300 are completed for all persons in the image frame (operation S310). When it is determined that the person-to-person distance calculation operation S100 and the proximity event generation operation S300 are not completed for all the persons in the image frame, the next two persons are selected and the process returns to the person-to-person distance calculation operation S100. When it is determined that the person-to-person distance calculation operation S100 and the proximity event generation operation S300 are completed for all the persons in the image frame, the process returns to an image frame acquisition operation S210 in order to acquire and process a subsequent image frame.

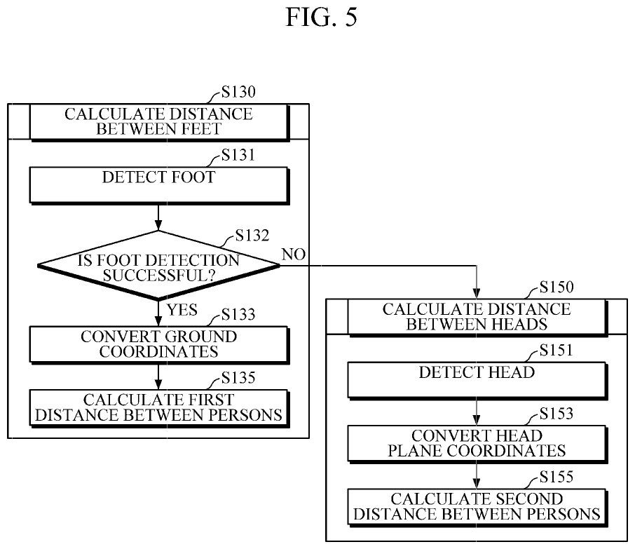

FIG. 5 is a flowchart illustrating detailed procedures of a foot-to-foot distance calculation operation and a head-to-head distance calculation operation according to an embodiment. According to an additional aspect, the foot-to-foot distance calculation operation S130 may include a foot detection operation S131, a ground coordinate conversion operation S133, and a first person-to-person distance calculation operation S135. In the foot detection operation S131, the surveillance apparatus detects the feet of the two persons from the image captured by the camera 710 and obtains a pair of first position coordinates which are coordinates of the image coordinate system. Thereafter, in the foot detection operation S131, it is determined whether the detection of the feet is successful (operation S132). When it is determined that the detection of the feet is successful, the ground coordinate conversion operation S133 proceeds. When it is determined that the detection of the feet is unsuccessful, the head-to-head distance calculation operation S150 proceeds. In the ground coordinate conversion operation S133, the surveillance apparatus converts the pair of first position coordinates into a pair of second position coordinates of a ground coordinate system by using camera parameters. In the first person-to-person distance calculation operation S135, the surveillance apparatus calculates a distance between the pair of second position coordinates and outputs the calculated distance as a value of the person-to-person distance. Since the above operations have been described with reference to FIG. 1, detailed descriptions thereof will be omitted.

According to an additional aspect, the head-to-head distance calculation operation S150 may include a head detection operation S151, a head plane coordinate conversion operation S153, and a second person-to-person distance calculation operation S155. In the head detection operation S151, the surveillance apparatus detects the feet of the two persons from the image captured by the camera and obtains a pair of third position coordinates, which are coordinates of the image coordinate system. In the head plane coordinate conversion operation S153, the surveillance apparatus converts the pair of third position coordinates into a pair of fourth position coordinates of a head plane coordinate system corresponding to an average height of persons using the camera parameters. According to an additional aspect, in the foot detection operation S131, the surveillance apparatus detects regions at which two persons of whom the distance is intended to be measured are positioned, detects the feet of the two persons, and then calls the head-to-head distance calculation operation S150 when the surveillance apparatus fails to detect the feet of the two persons. Accordingly, when the surveillance apparatus fails to detect the distance between the feet, the calculation of the distance between the heads may be applied.

According to an additional aspect, the person-to-person distance calculation operation S100 may further include a direct camera-to-person distance calculation operation S170. In the direct camera-to-person distance calculation operation S170, the surveillance apparatus detects the heads of the persons in a circle having a predetermined size based on a center of a screen in an image input from a wide angle camera 730 that is installed to face downward and converts the number of pixels between the detected heads of the persons into a distance to calculate the person-to-person distance. Since the above operations have been described with reference to FIG. 1, detailed descriptions thereof will be omitted.

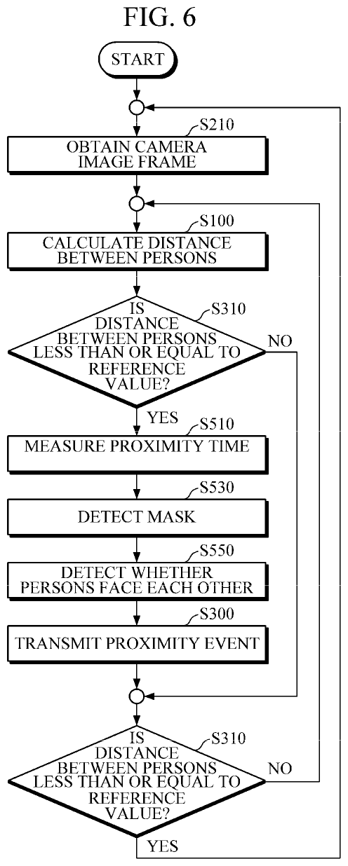

FIG. 6 is a flowchart illustrating a procedure of a video surveillance method for congestion control according to another embodiment. According to an aspect, the video surveillance method may further include a proximity time measurement operation S510. In the proximity time measurement operation S510, the video surveillance apparatus measures and outputs a proximity maintenance time for which a corresponding distance between the two persons is maintained when a proximity event occurs. In this case, in the proximity event generation operation S300, the video surveillance apparatus receives the value of the person-to-person distance output in the person-to-person distance calculation operation S100 and the proximity maintenance time output in the proximity time measurement operation S510 as inputs and transmits the proximity event according to a distance reference value for each proximity maintenance time.

According to another aspect, the video surveillance method may further include a mask detection operation S530. In the mask detection operation S530, the video surveillance apparatus determines whether the two persons wear masks when the proximity event occurs. In this case, in the proximity event generation operation S300, the video surveillance apparatus receives the value of the person-to-person distance output in the person-to-person distance calculation operation S100 and information on whether the two persons wear the masks output in the mask detection operation S530 as inputs and transmits the proximity event according to a distance reference value according to whether the two persons wear the masks.

According to another aspect, the video surveillance method may further include a face-to-face detection operation S550. In the face-to-face detection operation S550, the video surveillance apparatus determines whether the two persons face each other when the proximity event occurs. In this case, in the proximity event generation operation S300, the video surveillance apparatus receives the value of the person-to-person distance output in the person-to-person distance calculation operation S100 and information on whether the two persons face each other output in the face-to-face detection operation S550 as inputs and transmits the proximity event according to whether the two persons face each other.

In the embodiment illustrated in FIG. 6, in the proximity event generation operation S300, the video surveillance apparatus receives the value of the person-to-person distance output in the person-to-person distance calculation operation S100, the proximity maintenance time output in the proximity time measurement operation S510, the information on whether the two persons wear the masks output in the mask detection operation S530, and the information on whether the two persons face each other output in the face-to-face detection operation S550 as inputs and transmits the proximity event according to a reference value set according to a combination thereof. Here, the reference value may be set in advance for each combination of the range of the proximity time, whether the two persons wear the masks, and whether the two persons face each other.

Since a distance between persons is automatically calculated using an image captured by a camera and is generated as a proximity event, managers can control spaces in response to the proximity event. Further, an image at the moment of occurrence of the proximity event can be stored and checked as a proximity event image, and thus a precise epidemiologic investigation is possible in case of an emergency.

While the present invention has been described with reference to the embodiments and drawings, the present invention is not limited thereto. It should be understood that various modifications from the embodiments may be apparent to those skilled in the art. Appended claims are intended to include such modifications.

What is claimed is:

1. A video surveillance apparatus comprising:
a camera;
a person-to-person distance calculation unit configured to calculate a value of a person-to-person distance, which is a value of a distance between two persons, in an image captured by the camera; and
a proximity event generation unit configured to transmit a proximity event when the calculated value of the person-to-person distance is less than or equal to a reference value.

2. The video surveillance apparatus of claim 1, wherein the person-to-person distance calculation unit includes a foot-to-foot distance calculation unit configured to detect feet of two persons from the image captured by the camera and calculate a value of a person-to-person distance using coordinates of an image coordinate system of the image.

3. The video surveillance apparatus of claim 2, wherein the foot-to-foot distance calculation unit includes:
a foot detection unit configured to detect the feet of the two persons from the image captured by the camera and obtain a pair of first position coordinates which are the coordinates of the image coordinate system;
a ground coordinate conversion unit configured to convert the pair of first position coordinates into a pair of second position coordinates of a ground coordinate system by using camera parameters; and
a first person-to-person distance calculation unit configured to calculate a distance between the pair of second position coordinates and output the calculated distance as the value of the person-to-person distance.

4. The video surveillance apparatus of claim 1, wherein the person-to-person distance calculation unit includes a head-to-head distance calculation unit configured to detect heads of two persons from the image captured by the camera and calculate a value of a person-to-person distance using coordinates of an image coordinate system of the image.

5. The video surveillance apparatus of claim 4, wherein the head-to-head distance calculation unit includes:
a head detection unit configured to detect the heads of the two persons from the image captured by the camera and obtain a pair of third position coordinates which are the coordinates of the image coordinate system;
a head plane coordinate conversion unit configured to convert the pair of third position coordinates into a pair of fourth position coordinates of a head plane coordinate system corresponding to an average height of persons by using camera parameters; and
a second person-to-person distance calculation unit configured to calculate a distance between the pair of fourth position coordinates and output the calculated distance as the value of the person-to-person distance.

6. The video surveillance apparatus of claim 2, wherein the person-to-person distance calculation unit further includes a head-to-head distance calculation unit configured to detect heads of the two persons when the foot-to-foot distance calculation unit fails to detect the feet of the two persons from the image captured by the camera and configured to calculate the value of the person-to-person distance using the coordinates of the image coordinate system.

7. The video surveillance apparatus of claim 2, wherein the person-to-person distance calculation unit includes a direct camera-to-person distance calculation unit configured to detect heads of persons in a circle having a predetermined size based on a center of a screen in the image input from a wide angle camera that is installed to face downward and configured to convert the number of pixels between the detected heads of the persons into a distance.

8. The video surveillance apparatus of claim 1, further comprising a proximity time measurement unit configured to measure and output a proximity maintenance time for which a corresponding distance between the two persons is maintained when the proximity event occurs,
wherein the proximity event generation unit receives the value of the person-to-person distance output from the person-to-person distance calculation unit and the proximity maintenance time output from the proximity time measurement unit as inputs and transmits the proximity event according to a distance reference value for each proximity maintenance time.

9. The video surveillance apparatus of claim 1, further comprising a mask detection unit configured to determine whether the two persons wear masks when the proximity event occurs,
wherein the proximity event generation unit receives the value of the person-to-person distance output from the person-to-person distance calculation unit and information on whether the two persons wear the masks output from the mask detection unit as inputs and transmits the proximity event according to a distance reference value according to whether the two persons wear the masks.

10. The video surveillance apparatus of claim 1, further comprising a face-to-face detection unit configured to determine whether the two persons face each other when the proximity event occurs,
wherein the proximity event generation unit receives the value of the person-to-person distance output from the person-to-person distance calculation unit and information on whether the two persons face each other output from the face-to-face detection unit as inputs and transmits the proximity event according to whether the two persons face each other.

11. A video surveillance method that is executable in a video surveillance apparatus connected to at least one camera, the video surveillance method comprising:
a person-to-person distance calculation operation of calculating a value of a person-to-person distance, which is a value of a distance between two persons, in an image captured by the camera; and
a proximity event generation operation of transmitting a proximity event when the calculated value of the person-to-person distance is less than or equal to a reference value.

12. The video surveillance method of claim 11, wherein the person-to-person distance calculation operation includes a foot-to-foot distance calculation operation of detecting feet of two persons from the image captured by the camera and calculating a value of a person-to-person distance using coordinates of an image coordinate system of the image.

13. The video surveillance method of claim 12, wherein the foot-to-foot distance calculation operation includes:
a foot detection operation of detecting the feet of the two persons from the image captured by the camera and obtaining a pair of first position coordinates which are coordinates of the image coordinate system;
a ground coordinate conversion operation of converting the pair of first position coordinates into a pair of second position coordinates of a ground coordinate system by using camera parameters; and
a first person-to-person distance calculation operation of calculating a distance between the pair of second position coordinates and outputting the calculated distance as a value of the person-to-person distance.

14. The video surveillance method of claim 11, wherein the person-to-person distance calculation operation includes a head-to-head distance calculation operation of detecting heads of two persons from the image captured by the camera and calculating a value of a person-to-person distance using coordinates thereof of an image coordinate system of the image.

15. The video surveillance method of claim 14, wherein the head-to-head distance calculation operation includes:
a head detection operation of detecting the heads of the two persons from the image captured by the camera and obtaining a pair of third position coordinates which are coordinates of the image coordinate system;
a head plane coordinate conversion operation of converting the pair of third position coordinates into a pair of fourth position coordinates of a head plane coordinate system corresponding to an average height of persons by using camera parameters; and
a second person-to-person distance calculation operation of calculating a distance between the pair of fourth position coordinates and outputting the calculated distance as the value of the person-to-person distance.

16. The video surveillance method of claim 12, wherein the person-to-person distance calculation operation further includes a head-to-head distance calculation operation of detecting heads of the two persons when the foot-to-foot distance calculation operation fails to detect the feet of the two persons from the image captured by the camera and calculating the value of the person-to-person distance using the coordinates of the image coordinate system.

17. The video surveillance method of claim 11, further comprising a proximity time measurement operation of measuring and outputting a proximity maintenance time for which the corresponding distance between the two persons is maintained when the proximity event occurs,
wherein, in the proximity event generation operation, the value of the person-to-person distance output in the person-to-person distance calculation operation and the proximity maintenance time output in the proximity time measurement operation are received as inputs and the proximity event is transmitted according to a distance reference value for each proximity maintenance time.

18. The video surveillance method of claim 11, further comprising a mask detection operation of determining whether the two persons wear masks when the proximity event occurs,
wherein, in the proximity event generation operation, the value of the person-to-person distance output in the person-to-person distance calculation operation and information on whether the two persons wear the masks output in the mask detection operation are received as inputs and the proximity event is transmitted according to a distance reference value according to whether the two persons wear the masks.

19. The video surveillance method of claim 11, further comprising a face-to-face detection operation of determining whether the two persons face each other when the proximity event occurs,
wherein, in the proximity event generation operation, the value of the person-to-person distance output in the person-to-person distance calculation operation and information on whether the two persons face each other output in the face-to-face detection operation are received as inputs and the proximity event is transmitted according to whether the two persons face each other.
